(19) United States
(12) Patent Application Publication
(10) Pub. No.: US 2025/0136834 A1
(43) Pub. Date: May 1, 2025

(54) Conductive Ink with Carbon Nanostructures

(71) Applicant: Cabot Corporation, Boston, MA (US)

(72) Inventors: Xiaofeng Zhang, Shrewsbury, MA (US); Jeffrey W. Gamble, North Andover, MA (US); Sean S. Sullivan, Lynn, MA (US)

(21) Appl. No.: 18/833,493

(22) PCT Filed: Jan. 24, 2023
(86) PCT No.: PCT/US2023/061162

§ 371 Date: Jul. 26, 2024

Related U.S. Application Data
(60) Provisional application No. 63/304,064, filed on Jan. 28, 2022.

(51) Int. Cl. C09D 11/52; C09D 11/03

(52) U.S. Cl. CPC C09D 11/52; C09D 11/03

(57) ABSTRACT

Conductive inks containing carbon nanostructures (CNS) are used to produce electrothermal heating elements. The use of carbon nanostructures decreases the amount of other conductive fillers, including metallic fillers, required to achieve similar temperatures. Small amounts of carbon nanostructures are used to formulate inks that can achieve temperatures in excess of 300° F. (149° C.).

### BACKGROUND OF THE INVENTION

### 1. Field of the Invention

This invention relates to electrothermal conductive inks with carbon nanostructures.

### 2. Description of the Related Art

Conductive inks have been adopted to print conductors, resistors and sensors in electronics and devices for decades. Conductive inks can be printed on flexible polymer-based substrate or fused into a solid substrate like glass windows. One interesting application for conductive ink is to print heating elements that can be used in a variety application including heated floors, windows and walls, clothing and housewares (e.g., appliances and coffee mugs), and automotive. The conventional ink for this application contains silver or carbon based conductive fillers (e.g., graphite, carbon black). Using silver is effective to provide a conductive pathway, but not an economic approach. Without proper design of the heating element and circuit, the silver ink can be over heated to distort polymer substrates and cause safety concerns. Graphite and carbon black can be used as resistors for heating, but the heating rate and peak temperature appear to be insufficient for certain applications where higher performance is needed. Thus, it is desirable to have a conductive ink formulation that is more economical than 100% silver solutions but that provide improved performance in comparison to graphite and carbon black.

### SUMMARY OF THE INVENTION

In one embodiment, a conductive ink comprises 0.05 wt % to 30 wt % (dry basis), for example, 0.1 wt % to 20 wt %, 0.5 wt % to 10 wt %, or 0.75 wt % to 5 wt %, of at least one CNS-derived material selected from the group consisting of carbon nanostructures, fragments of carbon nanostructures, and fractured carbon nanotubes, and a binder in a liquid vehicle. For example, the ink may include 0.01 to 10 wt %, e.g., 0.05 wt % to 9 wt %, 0.1 wt % to 8 wt %, 0.5 wt % to 7 wt %, or 1 wt % to 5 wt %, CNS-derived material, based on the total mass of the conductive ink. The liquid vehicle may include an organic solvent, water, or both. The binder may include \a polymer, a monomer, an oligomer, or a blend of two or more of these.

In any of these embodiments, the conductive ink may further include a dispersant, for example, a non-ionic dispersant, an anionic dispersant, or a cationic dispersant. Alternatively or in addition, the conductive ink may further include one or more additives selected from a conductive additive, a stabilizer, an antioxidant, an adhesion promoter, and a viscosity modifier. The additive may be a conductive additive selected from silver, copper, gold, platinum, palladium, ruthenium, copper, nickel, zinc, and conductive oxides. The conductive additive may be in the form of spheres flakes, rods, or wires. The conductive additive may be present in an amount from 0 to 99% on a dry basis, for example, from 1 wt % to 90 wt %, from 5 wt % to 80 wt %, from 10 wt % to 70 wt %, from 20 wt % to 60 wt %, from 30 wt % to 50 wt %, from 40 wt % to 75 wt %, or from 50 wt % to 95 wt %.

In any of these embodiments, when the conductive ink is screen printed and cured, the resulting coating may achieve a temperature of at least 300° F. (149° C.) under 40 V of applied voltage. Alternatively or in addition, the conductive ink may include up to 85% (dry basis), for example, 65%-83%, of a metallic particulate, and, when screen printed and cured, the resulting coating may have a surface resistivity less than a coating having the same composition but without CNS-derived material.

A substrate may have the conductive ink of any of these embodiments printed thereon and cured. The cured ink may have a thickness from 0.1 microns to 100 microns, for example, from 0.5 microns to 80 microns, from 1 micron to 50 microns, from 5 microns to 30 microns, from 10 microns to 70 microns, from 30 microns to 60 microns, or from 50 microns to 90 microns. The cured ink may have a volume resistivity of 10⁻⁶ to 10¹⁴ ohm·cm, for example, from 10⁻⁵ to 5×10¹³, from 10f to 10¹³, from 10⁻³ to 5×10¹², from 10⁻² to 10¹², from 0.1 to 5×10¹¹ ohm·cm, from 1 to 10⁶ ohm·com, at most 0.1 ohm·cm, at most 1 ohm·cm, at most 10 ohm·cm, at most 100 ohm·cm, at most 10⁴ ohm·cm, at most 10⁶ ohm·cm, from 10⁶ to 10¹⁰ ohm·com, from 10¹⁰ to 10¹² ohm·cm, or from 10¹² to 10¹⁴ ohm·cm. The cured ink may have a surface resistivity of 10⁻⁶ to 10¹⁴ ohm/sq, e.g., from 10⁻⁵ to 5×10¹³, from 10⁻⁴ to 10¹³, from 10⁻³ to 5×10¹², from 10⁻² to 10¹², from 0.1 to 5×10¹¹ ohm/sq, from 1 to 10⁶ ohm·com, at most 0.1 ohm/sq, at most 1 ohm/sq, at most 10 ohm/sq, at most 100 ohm/sq, at most 10⁴ ohm/sq, at most 10⁶ ohm/sq, from 10⁶ to 10¹⁰ ohm·com, from 10¹⁰ to 10¹² ohm/sq, or from 10¹² to 10¹⁴ ohm/sq.

For any of these embodiments, substrate may include fabric, paper, wood, metal, glass, ceramic, concrete, polymer, or mixtures or composites of two or more of these. For example, the substrate may include a polyolefin, polyimide, polyester, polyurethane, or vinyl polymer, e.g., polyethylene, polyethylene terephthalate, polyvinyl chloride, or polystyrene. The substrate may be a film, a woven fabric, or a non-woven fabric.

It is to be understood that both the foregoing general description and the following detailed description are exemplary and explanatory only and are intended to provide further explanation of the present invention, as claimed.

### BRIEF DESCRIPTION OF THE DRAWING

The invention is described with reference to the several figures of the drawing, in which,

FIGS. 1A and 1B are diagrams illustrating differences between a Y-shaped MWCNT, not in or derived from a carbon nanostructure (FIG. 1A), and a branched MWCNT (FIG. 1B) in a carbon nanostructure.

FIGS. 2A and 2B are TEM images showing features characterizing multiwall carbon nanotubes found in carbon nanostructures.

FIG. 3A is an illustrative depiction of a carbon nanostructure flake material after isolation of the carbon nanostructure from a growth substrate;

FIG. 3B is a SEM image of an illustrative carbon nanostructure obtained as a flake material;

FIG. 4 is an optical micrograph of a printed ink formulation according to an exemplary embodiment (scale bar=1 mm).

FIG. 5A, 5B, and 5C are schematic diagrams showing the formation of a heating element for use in testing conductive inks.

### DETAILED DESCRIPTION OF THE INVENTION

A conductive ink includes 0.05 wt % to 30 wt % (dry basis) carbon nanostructures and a binder in a liquid vehicle. In one embodiment, the conductive ink is used in an electrothermal heater. The conductive ink is printed on a substrate to produce heater stripes, e.g., in a cross hatched or other appropriate pattern. The heater stripes may be connected to a power source, e.g., a battery, using low resistance traces formed from a high conductivity ink, metal wire, or other trace material known to those of skill in the art. Depending on the size of the heater, it may be desirable to have one or more conductive busses to distribute voltage to various groups of heater stripes. The power source is in electrical communication with the heater stripes via the low resistance traces and optional conductive busses. Any of these components may be deposited by any technique known to those of skill in the art, for example, screen printing, bubble jet printing, electrohydrodynamic printing, ink jet printing, aerosol jet printing, etc. Conductive inks as disclosed herein may be deposited as a single layer (i.e., a single printing pass) or in more than one layer. Additional layers increase thickness and may lower resistivity of the printed, cured ink. Where inks are used, they may be cured by air drying, heat, UV exposure, infrared exposure, chemical methods, or other methods known to those of skill in the art.

The substrate may be any suitable rigid or flexible substance. Fabric, paper, wood, metals, glass, ceramics, concrete, plastics and/or other polymers or composites may be used. Suitable polymers include polyolefins such as polyethylene, polyimides, polyesters such as polyethyleneterephthalate, polyurethanes, vinyl polymers such as polyvinyl chloride, polystyrene, and polyesters. Of course, any of these polymers may be used as a film, as a woven or non-woven fabric, or as a rigid bulk. A non-conductive substrate may be preferred to better control electrically conductive path through the heater.

The electrothermal heater may be configured in any manner known to those of skill in the art. One exemplary configuration is described in US20200396797, the entire contents of which are incorporated herein by reference.

The conductive ink includes carbon nanostructures (CNS) and/or CNS-derived material (e.g., CNS, fragments of CNSs or in fractured CNTs). As known in the art, carbon nanotubes (CNT or CNTs plural) are carbonaceous materials that include at least one sheet of sp²-hybridized carbon atoms bonded to each other to form a honey-comb lattice that forms a cylindrical or tubular structure. The carbon nanotubes can be single-walled carbon nanotubes (SWCNTs) or multi-walled carbon nanotubes (MWCNTs). SWCNTs can be thought of as an allotrope of sp²-hybridized carbon similar to fullerenes. The structure is a cylindrical tube including six-membered carbon rings. Analogous MWCNTs, on the other hand, have several tubes in concentric cylinders. The number of these concentric walls may vary, e.g., from 2 to 25 or more. Typically, the diameter of MWNTs may be 10 nm or more, in comparison to 0.7 to 2.0 nm for typical SWNTs.

In many of the CNSs used in various embodiments, the CNTs are MWCNTs, having, for instance, at least two coaxial carbon nanotubes. The number of walls present, as determined, for example, by transmission electron microscopy (TEM), at a magnification sufficient for analyzing the number of wall in a particular case, can be within the range of from 2 to 30 or so, for example: 4 to 30; 6 to 30; 8 to 30; 10 to 30; 12 to 30; 14 to 30; 16 to 30; 18 to 30; 20 to 30; 22 to 30; 24 to 30; 26 to 30; 28 to 30; or 2 to 28, 4 to 28; 6 to 28; 8 to 28; 10 to 28, 12 to 28; 14 to 28; 16 to 28, 18 to 28; 20 to 28; 22 to 28; 24 to 28; 26 to 28; or 2 to 26; 4 to 26; 6 to 26; 8 to 26; 10 to 26; 12 to 26; 14 to 26; 16 to 26; 18 to 26; 20 to 26; 22 to 26; 24 to 26, or 2 to 24; 4 to 24; 6 to 24; 8 to 24; 10 to 24; 12 to 24; 14 to 24; 16 to 24; 18 to 24; 20 to 24; 22 to 24; or 2 to 22; 4 to 22; 6 to 22; 8 to 22; 10 to 22; 12 to 22; 14 to 22; 16 to 22; 18 to 22; 20 to 22; or 2 to 20; 4 to 20; 6 to 20; 8 to 20; 10 to 20; 12 to 20; 14 to 20; 16 to 20; 18 to 20; or 2 to 18; 4 to 18; 6 to 18; 8 to 18; 10 to 18; 12 to 18; 14 to 18; 16 to 18; or 2 to 16; 4 to 16; 6 to 16; 8 to 16; 10 to 16; 12 to 16; 14 to 16; or 2 to 14; 4 to 14; 6 to 14; 8 to 14; 10 to 14; 12 to 14; or 2 to 12; 4 to 12; 6 to 12; 8 to 12; 10 to 12; or 2 to 10; 4 to 10; 6 to 10; 8 to 10; or 2 to 8; 4 to 8; 6 to 8; or 2 to 6; 4 to 6; or 2 to 4.

Since a CNS is a polymeric, highly branched and crosslinked network of CNTs, at least some of the chemistry observed with individualized CNTs may also be carried out on the CNS. In addition, some of the attractive properties often associated with using CNTs also are displayed in materials that incorporate CNSs. These include, for example, electrical conductivity, attractive physical properties including maintaining or enabling good tensile strength when integrated into a silicone-based composition, thermal stability (sometimes comparable to that of diamond crystals or in-plane graphite sheets) and/or chemical stability, to name a few.

However, as used herein, the term “CNS” is not a synonym for individualized, un-entangled structures such as “monomeric” fullerenes (the term “fullerene” broadly referring to an allotrope of carbon in the form of a hollow sphere, ellipsoid, tube, e.g., a carbon nanotube, and other shapes). In fact, many embodiments of the invention highlight differences and advantages observed or anticipated with the use of CNSs as opposed to the use of their CNTs building blocks. Without wishing to be held to a particular interpretation, it is believed that the combination of branching, crosslinking, and wall sharing among the carbon nanotubes in a CNS reduces or minimizes the van der Waals forces that are often problematic when using individual carbon nanotubes in a similar manner, especially when it is desirable to prevent agglomeration.

In addition, or alternatively to performance attributes, CNTs that are part of or are derived from a CNS can be characterized by a number of features, at least some of which can be relied upon to distinguish them from other nanomaterials, such as, for instance, ordinary CNTs (namely CNTs that are not derived from CNSs and can be provided as individualized, pristine or fresh CNTs).

In many cases, a CNT present in or derived from a CNS has a typical diameter of 100 nanometers (nm) or less, such as, for example, within the range of from about 5 to about 100 nm, e.g., within the range of from about 10 to about 75, from about 10 to about 50, from about 10 to about 30, from about 10 to about 20 nm.

In specific embodiments, at least one of the CNTs has a length that is equal to or greater than 2 microns, as determined by SEM. For example, at least one of the CNTs will have a length within a range of from 2 to 2.25 microns; from 2 to 2.5 microns; from 2 to 2.75 microns; from 2 to 3.0 microns; from 2 to 3.5 microns; from 2 to 4.0 microns; or from 2.25 to 2.5 microns; from 2.25 to 2.75 microns; from 2.25 to 3 microns; from 2.25 to 3.5 microns; from 2.25 to 4 microns; or from 2.5 to 2.75 microns, from 2.5 to 3 microns; from 2.5 to 3.5 microns; from 2.5 to 4 microns; or from 3 to 3.5 microns; from 3 to 4 microns; of from 3.5 to 4 microns or higher. In some embodiments, more than one, e.g., a portion such as a fraction of at least about 0.1%, at least about 1%, at least about 10%, at least about 15%, at least about 20%, at least about 25%, at least about 30%, at least about 35%, at least about 40, at least about 45%, at least about 50% or even more than one half, of the CNTs, as determined by SEM, can have a length greater than 2 microns, e.g., within the ranges specified above.

For many CNTs in a CNS, at least a portion of a CNT sidewall is shared with another CNT. While it is generally understood that every carbon nanotube in the CNS need not necessarily be branched, crosslinked, or share common walls with other CNTs, at least a portion of the CNTs in the carbon nanostructure can be interdigitated with one another and/or with branched, crosslinked, or common-wall carbon nanotubes in the remainder of the carbon nanostructure.

The morphology of CNTs present in a CNS, in a fragment of a CNS or in a fractured CNT derived from a CNS will often be characterized by a high aspect ratio, with lengths typically more than 100 times the diameter, and in certain cases much higher. For instance, in a CNS (or CNS fragment), the length to diameter aspect ratio of CNTs can be within a range of from about 200 to about 1000, such as, for instance, from 200 to 300; from 200 to 400; from 200 to 500; from 200 to 600; from 200 to 700; from 200 to 800; from 200 to 900; or from 300 to 400; from 300 to 500; from 300 to 600; from 300 to 700; from 300 to 800, from 300 to 900; from 300 to 1000; or from 400 to 500; from 400 to 600; from 400 to 700; from 400 to 800; from 400 to 900; from 400 to 1000; or from 500 to 600; from 500 to 700; from 500 to 800, from 500 to 900; from 500 to 1000; or from 600 to 700; from 600 to 800; from 600 to 900; from 600 to 1000; from 700 to 800; from 700 to 900; from 700 to 1000; or from 800 to 900; from 800 to 1000; or from 900 to 1000.

It has been found that in CNSs, as well as in structures derived from CNSs (CNS-derived material, e.g., CNS, fragments of CNSs or fractured CNTs) at least one of the CNTs is characterized by a certain “branch density”. As used herein, the term “branch” refers to a feature in which a single carbon nanotube diverges into multiple (two or more), connected multiwall carbon nanotubes. One embodiment has a branch density according to which, along a two-micrometer length of the carbon nanostructure, there are at least two branches, as determined by SEM. Three or more branches also can occur.

In addition, or in the alternative, the number of walls observed at the area (point) of branching in a CNS, fragment of CNSs or fractured CNTs differ from one side of the branching (e.g., before the branching point) to the other side of this area (e.g., after or past the branching point). Such a change in the number of walls, also referred to herein as an “asymmetry” in the number of walls, is not observed with ordinary Y-shaped CNTs (where the same number of walls is observed in both the area before and the area past the branching point).

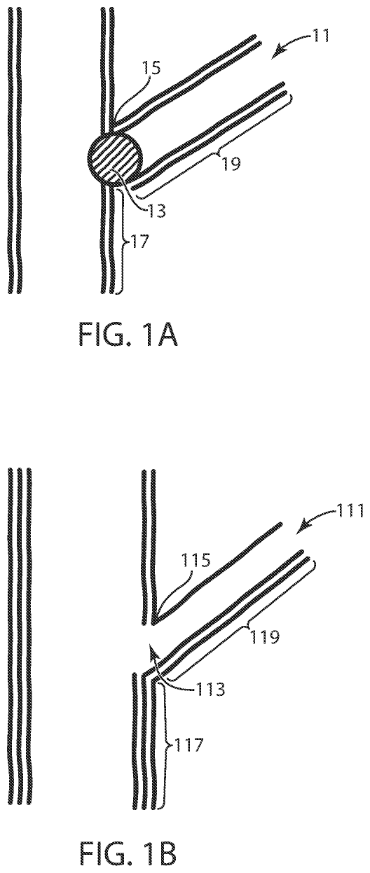

Diagrams illustrating these features are provided in FIGS. 1A and 1B. Shown in FIG. 1A, is an exemplary Y-shaped CNT 11 that is not derived from a CNS. Y-shaped CNT 11 includes catalyst particle 13 at or near branching point 15. Areas 17 and 19 are located, respectively, before and after the branching point 15. In the case of a Y-shaped CNT such as Y-shaped CNT 11, both areas 17 and 19 are characterized by the same number of walls, i.e., two walls in the drawing.

In contrast, in a CNS (FIG. 1B), a CNT building block 111, that branches at branching point 115, does not include a catalyst particle at or near this point, as seen at catalyst devoid region 113. Furthermore, the number of walls present in region 117, located before, prior (or on a first side of) branching point 115 is different from the number of walls in region 119 (which is located past, after or on the other side relative to branching point 115. In more detail, the three-walled feature found in region 117 is not carried through to region 119 (which in the diagram of FIG. 1B has only two walls), giving rise to the asymmetry mentioned above.

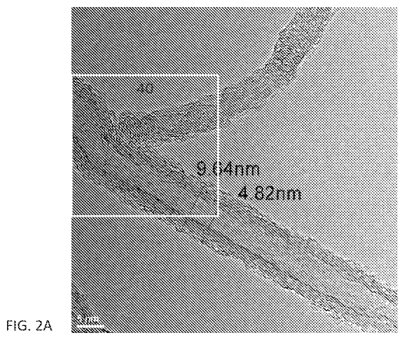

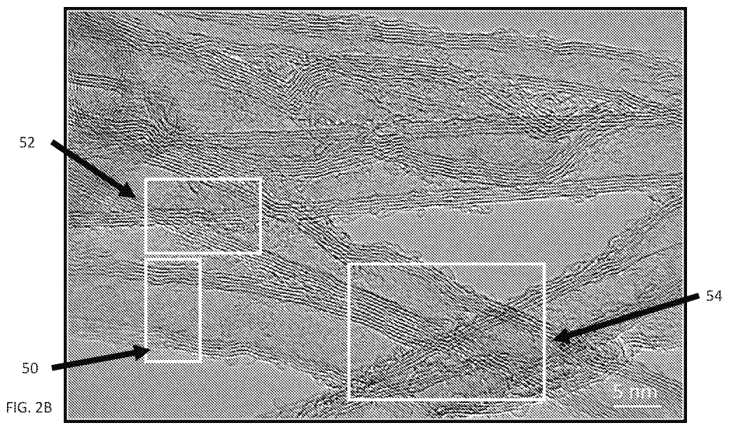

These features are highlighted in the TEM images of FIGS. 2A and 2B.

In more detail, the CNS branching in TEM region 40 of FIG. 2A shows the absence of any catalyst particle. In the TEM of FIG. 2B, first channel 50 and second channel 52 point to the asymmetry in the number of walls featured in branched CNSs, while arrow 54 points to a region displaying wall sharing.

One, more, or all these attributes can be encountered in the coating compositions described herein.

In some embodiments, the CNS is present as part of an entangled and/or interlinked network of CNSs. Such an interlinked network can contain bridges between CNSs.

Suitable techniques for preparing CNSs are described, for example, in U.S. Patent Application Publication No. 2014/0093728 A1, published on Apr. 3, 2014, U.S. Pat. Nos. 8,784,937B2; 9,005,755B2; 9,107,292B2; and 9,447,259B2. The entire contents of these documents are incorporated herein by this reference.

As described in these documents, a CNS can be grown on a suitable substrate, for example on a catalyst-treated fiber material. The product can be a fiber-containing CNS material. In some cases, the CNSs are separated from the substrate to form flakes.

As seen in US 2014/0093728A1 a carbon nanostructure obtained as a flake material (i.e., a discrete particle having finite dimensions) exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the CNS can be modulated to some degree by adjusting the carbon nanostructure growth conditions, including, for example, by changing the concentration of transition metal nanoparticle catalyst particles that are disposed on the growth substrate to initiate carbon nanotube growth.

The flakes can be further processed, e.g., by cutting or fluffing (operations that can involve mechanical ball milling, grinding, blending, etc.), chemical processes, or any combination thereof.

In some embodiments, the CNSs employed are “coated”, also referred to herein as “encapsulated” CNSs. In a typical coating process, the coating is applied onto the CNTs that form the CNS. The coating process can form a partial or a complete coating that is non-covalently bonded to the CNTs and, in some cases, can act as a binder. In addition, or in the alternative, the coating can be applied to already formed CNSs in a post-coating (or encapsulation) process. With coatings that have binding properties, CNSs can be formed into larger structures, granules or pellets, for example. In other embodiments the granules or pellets are formed independently of the function of the coating.

For example, the flake material can be captured and sprayed with an aqueous solution containing a binder (e.g., polyethylene glycol or polyurethane) to form wet flakes. The weight ratio of aqueous binder solution to the flake material can range from 8:1 to 15:1, e.g., from 10:1 to 15:1, from 10:1 to 13:1, or from 10:1 to 12:1. The wet flakes can then be extruded to form wet extrudates. Drying the wet extrudates (e.g., by air drying, drying in an oven) results in formation of the CNS pellets. Alternatively, drying the wet flakes results in formation of CNS granules.

Various types of coatings can be selected. In many cases, sizing solutions commonly used in coating carbon fibers or glass fibers could also be utilized as coating materials for CNSs. In these embodiments, relative to the overall weight of the coated CNS material, the coating can be within the range of from about 0.1 weight % to about 10 weight % (e.g., within the range, by weight, of from about 0.1% to about 0.5%; from about 0.5% to about 1%; from about 1% to about 1.5%; from about 1.5% to about 2%; from about 2% to about 2.5%; from about 2.5% to about 3%; from about 3% to about 3.5%; from about 3.5% to about 4%; from about 4% to about 4.5%; from about 4.5% to about 5%; from about 5% to about 5.5%; from about 5.5% to about 6%; from about 6% to about 6.5%, from about 6.5% to about 7%; from about 7% to about 7.5%; from about 7.5% to about 8%; from about 8% to about 8.5%; from about 8.5% to about 9%; from about 9% to about 9.5%; or from about 9.5% to about 10%. Specific examples of sizing materials include but are not limited to fluorinated polymers such as poly(vinyldifluoroethylene)(PVDF), poly(vinyldifluoroethylene-co-hexafluoropropylene)(PVDF-HFP), poly(tetrafluoroethylene)(PTFE), polyimides, and water-soluble binders, such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof. In many implementations, the CNSs used are treated with a polyurethane (PU), a thermoplastic polyurethane (TPU), or with polyethylene glycol (PEG). Polymers such as, for instance, epoxy, polyester, vinylester, polyetherimide, polyetherketoneketone, polyphthalamide, polyetherketone, polyetheretherketone, polyimide, phenol-formaldehyde, bismaleimide, acrylonitrile-butadiene styrene (ABS), polycarbonate, polyethyleneimine, polyurethane, polyvinyl chloride, polystyrene, polyolefins, polypropylenes, polyethylenes, polytetrafluoroethylene, elastomers such as, for example, polyisoprene, polybutadiene, butyl rubber, nitrile rubber, ethylene-vinyl acetate polymers, silicone polymers, and fluorosilicone polymers, combinations thereof, or other polymers or polymeric blends can also be used as sizing materials in some cases. In order to enhance electrical conductivity, conductive polymers such as, for instance, polyanilines, polypyrroles and polythiophenes can also be used.

Alternative implementations may utilize coating materials that can assist in stabilizing a CNS dispersion in an aqueous or organic liquid vehicle. In one example, the coating is selected to facilitate and/or stabilize dispersing CNSs and other CNS-derived material in a vehicle produced by combining the desired resin for the coating with a desired vehicle together with optional dispersant. Any suitable combination of the resins and vehicles provided above may be employed. In another example, the coating material is the same as, similar to, or compatible with a dispersant or thickener employed when processing CNSs. For example, CNS flake material may be coated with a suitable dispersant for use with the vehicle (e.g., organic or aqueous fluid) system in which the CNS-polymer resin composition is dissolved/dispersed. To provide an appropriate amount of dispersant for the liquid dispersion or other formulation, it may be desirable to increase the amount of the dispersant, as a coating material, in comparison to the coating amounts for CNS pellets or granules listed for the sizing materials described above. For example, relative to the mass of coated CNS material, the amount of dispersant may be at least 20% by weight, e.g., 25%-60%, 30%-55%, 40%-50%, or 45%-60%.

Exemplary dispersants include but are not limited to poly(vinyl pyrrolidone), poly(vinylpyrrolidone-co-vinyl acetate), poly(vinyl butyral), poly(vinyl alcohol), polyalkylene oxides (such as polyethylene oxide or polypropylene oxide), polyalkylene oxides or acrylic polymers comprising amine functional groups, poly(propylene carbonate), cellulosic dispersants such as methyl cellulose, carboxymethyl cellulose, ethyl cellulose, hydroxymethyl cellulose and hydroxypropyl cellulose, poly(carboxylic acid) such as poly(acrylic acid), polyacrylates, poly(methylacrylate), poly(acrylamide), amide wax, styrene maleic anhydride resins, amine-functionalized or amine-terminated compounds such as polyamine, tertiary amine, or quaternary ammonium functionalized compounds, e.g., tetraoctylammonium bromide, ethoxylates such as alkylphenol ethoxylates, e.g., octylphenol ethoxylate, or alkyl ethoxylates, multifunctional co-dispersants such as AMP™ dispersants, dispersants containing 2-amino-2-methyl-1-propanol, polyesters (such as polycaprolactone, polyvalerolactone, poly(hydroxy stearic acid), or poly(hydroxyoleic acid), polyamides such as polycaprolactam, and block copolymers having both a hydrophobic and a hydrophilic group. Other possible candidates include sodium dodecyl sulfate (SDS), sodium dodecyl benzyl sulfonate, derivatives of polyacrylic acid and so forth. Additional examples include amine-functionalized derivatives (such as polyamine, tertiary amine, or quaternary ammonium functionalized derivatives), acid functionalized derivatives (such as carboxylic acid or phosphonic acid functionalized deriviatives) of these, such as amine-functionalized or amine-terminated polyalkylene oxides or acrylic polymers comprising amine or acid functional groups. Other suitable dispersants include those that are known to those of skill in the art for use with carbon black, graphene, or carbon nanotubes. The compositions can include one dispersant or mixtures of two or more dispersants.

In one illustration, the dispersant belongs to a class that includes a styrene maleic anhydride resin and/or its derivatives, the latter being polymers made via a chemical reaction of styrene maleic anhydride resin or prehydrolyzed styrene maleic anhydride resin with small or large organic molecules having at least one reactive end group, for example an amine or epoxide group. In general, this class of polymeric dispersants (also referred to herein as styrene maleic anhydride-based) have a styrene maleic anhydride copolymer backbone modified with various polymeric brushes and/or small molecules.

In another illustration, the dispersant includes PVP (in various molecular weights) or its derivatives, the latter generally referring to dispersants that have a PVP backbone modified with small or large molecules via chemical reactions, for example. Examples of PVP-based dispersants include Ashland PVP K-12, K-15, K-30, K-60, K-90 and K-120 products, polyvinyl pyrrolidone copolymers such as polyvinyl pyrrolidone-co-vinyl acetate, butylated polyvinyl pyrrolidone such as Ganex™ P-904LC polymer.

In a further illustration, the dispersant is a cellulose-based dispersant, including, for instance, cellulose or cellulose derivatives, the latter having a cellulose backbone optionally modified by small or large organic molecules having at least one reactive end group. In one specific example, the cellulose-based dispersant is CMC (e.g., at various viscosities), a compound typically prepared by the reaction of cellulose with chloroacetic acid. In another example, the dispersant is hydroxyethyl cellulose.

Many embodiments described herein use CNS-derived materials that have a 97% or higher CNT purity. Often, the CNSs used herein require no further additives to counteract Van der Waals forces.

CNSs can be provided in the form of a loose particulate material (as CNS flakes, granules, pellets, etc., for example) or in formulations that also include a liquid medium, e.g., dispersions, slurries, pastes, or in other forms. In many implementations, the CNSs employed are separated from their growth substrate.

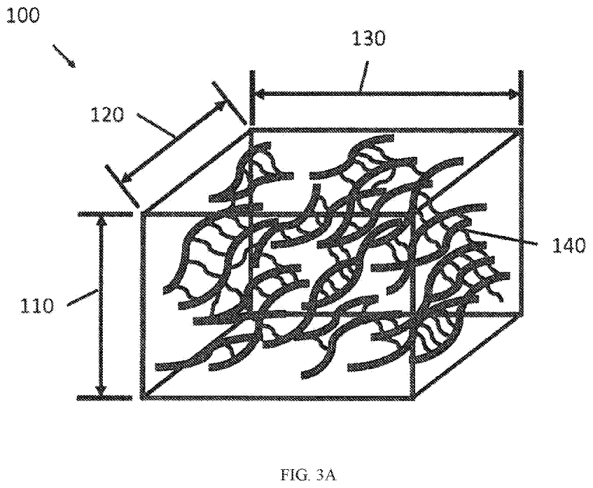

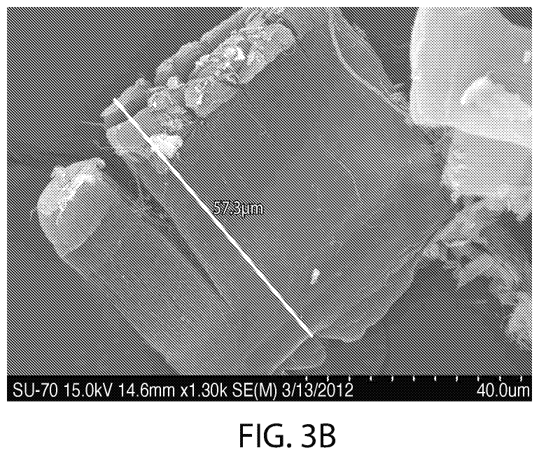

In some embodiments, the CNSs are provided in the form of a flake material after being removed from the growth substrate upon which the carbon nanostructures are initially formed. As used herein, the term “flake material” refers to a discrete particle having finite dimensions. Shown in FIG. 3A, for instance, is an illustrative depiction of a CNS flake material after isolation of the CNS from a growth substrate. Flake structure 100 can have first dimension 110 that is in a range from about 1 nm to about 35 microns thick, particularly about 1 nm to about 500 nm thick, including any value in between and any fraction thereof. Flake structure 100 can have second dimension 120 that is in a range from about 1 micron to about 750 microns tall, including any value in between and any fraction thereof. Flake structure 100 can have third dimension 130 that can be in a range from about 1 micron to about 750 microns, including any value in between and any fraction thereof. Two or all of dimensions 110, 120 and 130 can be the same or different.

For example, in some embodiments, second dimension 120 and third dimension 130 can be, independently, on the order of about 1 micron to about 10 microns, or about 10 microns to about 100 microns, or about 100 microns to about 250 microns, from about 250 to about 500 microns, or from about 500 microns to about 750 microns.

CNTs within the CNS can vary in length from about 10 nanometers (nm) to about 750 microns (μm), or higher. Thus, the CNTs can be from 10 nm to 100 nm, from 10 nm to 500 nm, from 10 nm to 750 nm; from 10 nm to 1 micron; from 10 nm to 1.25 micron; from 10 nm to 1.5 micron; from 10 nm to 1.75 micron; from 10 nm to 2 micron; or from 100 nm to 500 nm, from 100 nm to 750 nm; from 100 nm to 1 micron, from 100 to 1.25 micron; from 100 to 1.5 micron; from 100 to 1.75 micron from 100 to 2 microns; from 500 nm to 750 nm; from 500 nm to 1 micron; from 500 nm to 1 micron; from 500 nm to 1.25 micron; from 500 nm to 1.5 micron; from 500 nm to 1.75 micron; from 500 nm to 2 micron; from 750 nm to 1 micron; from 750 nm to 1.25 micron; from 750 nm to 1.5 micron; from 750 nm to 1.75 microns; from 750 nm to 2 microns; from 1 micron to 1.25 micron; from 1.0 micron to 1.5 micron; from 1 micron to 1.75 micron; from 1 micron to 2 microns; or from 1.25 micron to 1.5 micron; from 1.25 micron to 1.75 micron; from 1 micron to 2 microns; or from 1.5 to 1.75 micron; from 1.5 to 2 micron; or from 1.75 to 2 microns. In some embodiments, at least one of the CNTs has a length that is equal to or greater than 2 microns, as determined by SEM, for example, up to 4 microns or greater.

Shown in FIG. 3B is a SEM image of an illustrative carbon nanostructure obtained as a flake material. The carbon nanostructure shown in FIG. 3B exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the carbon nanostructure can be modulated to some degree by adjusting the carbon nanostructure growth conditions, including, for example, by changing the concentration of transition metal nanoparticle catalyst particles that are disposed on the growth substrate to initiate carbon nanotube growth.

A flake structure can include a webbed network of carbon nanotubes in the form of a carbon nanotube polymer (i.e., a “carbon nanopolymer”) having a molecular weight in a range from about 15,000 g/mol to about 150,000 g/mol, including all values in between and any fraction thereof. In some cases, the upper end of the molecular weight range can be even higher, including about 200,000 g/mol, about 500,000 g/mol, or about 1,000,000 g/mol. The higher molecular weights can be associated with carbon nanostructures that are dimensionally long. The molecular weight can also be a function of the predominant carbon nanotube diameter and number of carbon nanotube walls present within the carbon nanostructure. The crosslinking density of the carbon nanostructure can range between about 2 mol/cm³ to about 80 mol/cm³. Typically, the crosslinking density is a function of the carbon nanostructure growth density on the surface of the growth substrate, the carbon nanostructure growth conditions and so forth. It should be noted that the typical CNS structure, containing many, many CNTs held in an open web-like arrangement, removes Van der Waals forces or diminishes their effect. This structure can be exfoliated more easily, which makes many additional steps of separating them or breaking them into branched structures unique and different from ordinary CNTs.

With a web-like morphology, carbon nanostructures can have relatively low bulk densities, for example, from about 0.005 g/cm³ to about 0.1 g/cm³ or from about 0.01 g/cm³ to about 0.05 g/cm³. As-produced carbon nanostructures can have an initial bulk density ranging from about 0.003 g/cm³ to about 0.015 g/cm³. Further consolidation and/or coating to produce a carbon nanostructure flake material or like morphology can raise the bulk density to a range from about 0.1 g/cm³ to about 0.15 g/cm³. In some embodiments, optional further modification of the carbon nanostructure can be conducted to further alter the bulk density and/or another property of the carbon nanostructure. In some embodiments, the bulk density of the carbon nanostructure can be further modified by forming a coating on the carbon nanotubes of the carbon nanostructure and/or infiltrating the interior of the carbon nanostructure with various materials Coating the carbon nanotubes and/or infiltrating the interior of the carbon nanostructure can further tailor the properties of the carbon nanostructure for use in various applications. Moreover, forming a coating on the carbon nanotubes can desirably facilitate the handling of the carbon nanostructure. In some embodiments, further compaction can raise the bulk density to an upper limit of about 1 g/cm³, with chemical modifications to the carbon nanostructure raising the bulk density to an upper limit of about 1.2 g/cm³.

In addition to the flakes described above, the CNS material can be provided as granules, pellets, or in other forms of loose particulate material, having a typical particle size within the range of from about 1 mm to about 1 cm, for example, from about 0.5 mm to about 1 mm, from about 1 mm to about 2 mm, from about 2 mm to about 3 mm, from about 3 mm to about 4 mm, from about 4 mm to about 5 mm, from about 5 mm to about 6 mm, from about 6 mm to about 7 mm, from about 7 mm to about 8 mm, from about 8 mm to about 9 mm or from about 9 mm to about 10 mm.

Commercially, examples of CNS materials that can be utilized are those developed by Applied Nanostructured Solutions, LLC (ANS)(Massachusetts, United States).

The CNSs used herein can be identified and/or characterized by various techniques. Electron microscopy, including techniques such as transmission electron microscopy (TEM) and scanning electron microscopy (SEM), for example, can provide information about features such as the frequency of specific number of walls present, branching, the absence of catalyst particles, etc. See, e.g., FIGS. 2A-2B.

Raman spectroscopy can point to bands associated with impurities. For example, a D-band (around 1350 cm⁻¹) is associated with amorphous carbon; a G band (around 1580 cm⁻¹) is associated with crystalline graphite or CNTs). A G′ band (around 2700 cm⁻¹) is expected to occur at about 2X the frequency of the D band. In some cases, it may be possible to discriminate between CNS and CNT structures by thermogravimetric analysis (TGA).

The conductive ink may include the carbon nanostructures suspended in an appropriate liquid vehicle. The loading of CNS and/or CNS-derived material in the liquid vehicle may be up to 5 or 10 wt %, for example, 0.01 wt % to 10 wt %, 0.05 wt % to 9 wt %, 0.1 wt % to 8 wt %, 0.5 wt % to 7 wt %, or 1 wt % to 5 wt %. CNS-derived material may be present in the conductive ink in an amount sufficient to result (after printing and drying/curing) in a conductive coating having CNS-derived material present in an amount from 0.05 wt % to 30 wt % (dry basis), for example, 0.1 wt % to 20 wt %, 0.5 wt % to 10 wt %, or 0.75 wt % to 5 wt %. The vehicle may be a polar fluid, e.g., water or an aqueous vehicle having at least 50 wt % water. Alternatively, the vehicle may be or include organic solvents such as low molecular weight (e.g., C1-C10) hydrocarbons or aromatics such as alcohols, aldehydes, ketones, and ethers, dioxane, acetic acid, ppropylene glycol monomethyl ether (PGME), propylene glycol monomethyl ether acetate (PGMEA), dimethoxyethane, formic acid, acetonitrile, 1,4-dioxane, tetrahydrofuran, dimethyl formamide, dimethyl acetamide, n-methyl pyrrolidone, chlorobenzene, trichlorobenzene, trichloroethylene, or ethylene glycol. Examples of alcohols include methanol, ethanol, isopropanol, perfluoropropanol, 2-methylpropan-1-ol, 1-butanol, 2-butanol, 2-butoxyethanol, 2-(2-Butoxyethoxy) ethanol and octanol. Examples of aldehydes include formaldehyde, acetaldehyde, propionaldehyde, and glutaraldehyde. Examples of ketones include acetone, methylethylketone, methylpentan-2-one, and diethylketone. Example of esters include methyl acetate, ethyl acetate and phthalic acid butyl benzyl ester. Examples of hydrocarbons include hexane, heptane, octane, nonane, and decane, dichloromethane, chloroform, 1,1,1-trichloroethane, trichloroethylene, isophorone, 2-nitropropane, tetrachloroethylene, naptha, and acetonitrile. Examples of aromatics include benzene, toluene, xylene, 1,2,4-trimethylbenzene, phenol and naphthalene. Mixtures of two or more of these solvents may also be used.

Any suitable dispersant may be used to improve the dispersal and suspension of the CNS and other CNS-derived material in the vehicle. Dispersants can include surfactants, functionalized polymers and oligomers. Dispersants may be non-ionic dispersants or may be ionic dispersants which include both anionic and cationic dispersants. Dispersants may be amphiphilic and may be polymeric or include a polymeric group. Specific examples of polymeric dispersants include synthetic polymeric dispersants. Suitable molecular groups that may be included in dispersants include but are not limited to polyalkylene oxides such as polyethylene oxide, polypropylene oxide, and mixtures and copolymers thereof, polyesters such as polycaprolactones, polyvalerolactones, poly(hydroxystearic acid), and poly(hydroxyoleic acid), polyamides such as polycaprolactam, polyacrylates, poly vinyl pyrrolidone, and block copolymers having both hydrophilic and hydrophobic groups. Additional examples include amine-functionalized derivatives (such as polyamine, tertiary amine, or quaternary ammonium functionalized derivatives) of any of these, such as amine-functionalized or amine-terminated polyalkylene oxides (e.g., Jeffamine dispersants available from Huntsman) or acrylic polymers including amine or acid functional groups. Ethoxylates such as alkylphenol ethoxylates and alkyl ethoxylates are commonly used in waterborne formulations as dispersants. Examples include PETROLITE dispersants from Baker Petrolite. Additional polymers and related materials that can be used for dispersants and additives in conductive inks are included in the Tego products from Evonik, the Ethacryl products from Lyondell, the Joncryl polymers and EFKA dispersants from BASF, Solsperse™ dispersants available from Lubrizol, and the Disperbyk® and Byk® dispersants from BYK. Any of the dispersants described above in connection with coatings for CNS may additionally or alternatively be used as a dispersant in the conductive ink.

The conductive ink may further include conductive or non conductive additives. Conductive additives include silver, copper, gold, platinum, palladium, ruthenium, copper, nickel, zinc, conductive oxides, or other conductive particles and may be present in an amount from 0 to 99 wt % on a dry basis, for example, from 1 wt % to 90 wt %, from 5 wt % to 80 wt %, from 10 wt % to 70 wt %, from 20 wt % to 60 wt %, from 30 wt % to 50 wt %, from 40 wt % to 75 wt %, or from 50 wt % to 95 wt %. The conductive additive is generally particulate and may have any shape suitable for use in conductive inks, for example, spheres, flakes, rods, or wires. The conductive additives may have any size suitable for use in conductive inks, for example, up to 100 or 200 nm or a few hundred nanometers or up to tens of microns. The conductive ink may further include functional materials such as stabilizers, antioxidants, adhesion promoters, and viscosity modifiers that improve shelf life and printability of the ink.

The conductive ink may further include a binder. The binder may be a polymer, monomer, or oligomer. Following printing and ink cure, the cured binder may be a thermoset or thermoplastic polymer. Suitable polymers may form a gel in the liquid vehicle, e.g., poly(lactic acid), polystyrene, poly(methyl acrylate), poly(methyl methacrylate), poly(n-butyl acrylate), poly(2-hydroxyethyl methacrylate), poly(glycidyl methacrylate), poly(acrylic acid), poly(N-N-dimethylacrylamide), poly(l-vinyl anthracene), poly(2-vinyl pyridine), poly(4-vinyl pyridine), poly(N-vinyl carbazole), poly(N-vinyl carbazole), poly(N-vinyl imidazole), poly(vinyl benzyl chloride), poly(4-vinyl benzoic acid), poly(vinyl acetate), polycaprolactone, poly(11-[4-(4-butylphenylazo)phenoxy]-undecyl methacrylate)(poly(AzoMA)), poly(ferrocenyldimethylsilane), polyisoprene, polybutadiene, polyisobutylene, poly propylene glycol, poly(ethylene glycol), or a polysaccharide, such as chitosan, or a mixture thereof. Alternatively, a monomer or oligomer may be further polymerized by the application of heat, radiation (e.g., UV, visible, or IR), oxygen, or moisture. Suitable polymers that may be present in the coating following curing of the conductive ink include but are not limited to polyalkylenes, polyalkylene glycols, polyalkylene alcohols, polyacryloyl compounds, polyalkylene glycols, polyalkylene esters, polyolefins, vinyl polymers, alkoxylates, alkylol amides, esters, amine oxides, alkyl polyglucosides, alkylphenols, arylalkylphenols, polyvinyl alcohols, copolymers of polyvinyl alcohols and polyvinyl acetates, polyvinylpyrrolidones, cellulose, starch, gelatin, gelatin derivatives, amino acid polymers, polylysine, polyaspartic acid, polyacrylates, polyethylenesulfonates, polystyrenesulfonates, polymethacrylates, condensation products of aromatic sulfonic acids with formaldehyde, naphthalenesulfonates, lignosulfonates, copolymers of acrylic monomers, polyethylenimines, polyvinylamines, polyallylamines, poly(2-vinylpyridines), block copolyethers, block copolyethers having polystyrene blocks and/or polydiallyldimethylammonium chloride, and copolymers or mixtures thereof. Specific examples of polymers include polyethylene, polypropylene, chlorinated polypropylene, polyvinyl alcohol, polyvinyl acetate, polyacrylate, polymethacrylate, cellulose polysaccharides, polystyrol, and mixtures or copolymers thereof.

The coating resulting from printing and curing the conductive ink may have any suitable thickness, such as from 0.1 micron to 100 micron, for example, from 0.5 microns to 80 microns, from 1 micron to 50 microns, from 5 microns to 30 microns, from 10 microns to 70 microns, from 30 microns to 60 microns, or from 50 microns to 90 microns.

The coating resulting from printing and curing the conductive ink may have a volume resistivity of 10⁻⁶ to 10¹⁴ ohm·cm, e.g., from 10⁻⁵ to 5×10¹³, from 10⁻⁴ to 10¹³, from 10⁻³ to 5×10¹², from 10⁻² to 10¹², from 0.1 to 5×10¹¹ ohm·cm, from 1 to 10⁶ ohm·com, at most 0.1 ohm·cm, at most 1 ohm·cm, at most 10 ohm·cm, at most 100 ohm·cm, at most 10⁴ ohm·cm, at most 10⁶ ohm·cm, from 10⁶ to 10¹⁰ ohm·com, from 10¹⁰ to 10¹² ohm·cm, or from 10¹² to 10¹⁴ ohm·cm. Alternatively or in addition, the coating may have a surface resistivity of 10⁻⁶ to 10¹⁴ ohm/sq, e.g., from 10⁻⁵ to 5×10¹³, from 10⁻⁴ to 10¹³, from 10⁻³ to 5×10¹², from 10⁻² to 10¹², from 0.1 to 5×10¹¹ ohm/sq, from 1 to 10⁶ ohm·com, at most 0.1 ohm/sq, at most 1 ohm/sq, at most 10 ohm/sq, at most 100 ohm/sq. at most 10⁴ ohm/sq, at most 10⁶ ohm/sq, from 10⁶ to 10¹⁰ ohm·com, from 10¹⁰ to 10¹² ohm/sq, or from 10¹² to 10¹⁴ ohm/sq.

The coating resulting from printing, especially screen printing, and curing the conductive ink may, under applied voltage, e.g. a voltage from 5 to 45 V, achieve a temperature of at least 300° F. (149° C.), for example, from 300° F. (149° C.) to 600° F. (316° C.). That is, there is a voltage from 5 to 45 V at which the coating can achieve such a temperature. For example, the coating may achieve a temperature of at least 300° F. (149° C.), for example, from 300° F. (149° C.) to 600° F. (316° C.) at a voltage of 40 V.

The present invention will be further clarified by the following examples which are intended to be only exemplary in nature

### EXAMPLES

### Example 1

Conductive inks were prepared according to formulations in Table 1 with various amounts of polyethylene glycol coated carbon nanostructures (CNS)(Applied Nanostructured Solutions, Boston, MA)(Cabot Corporation, Boston MA). First, a thermoplastic resin binder solution was prepared. Pearlstick™ 5715 thermoplastic polyurethane elastomer (TPU) was dissolved in diethylene glycol monoethyl ether acetate solvent to form a 25% solid binder solution. The corresponding amount of CNS was added to the resin solution and mixed in a Speedmixer DAC 600.2 VAC (FlackTek) to form a thick paste. The pastes of Examples 1A, 1B and IC can also serve as CNS masterbatches, which can be further letdown to reduce loading.

The inks were screen printed onto Kapton polyimide films (136-137 microns thick) and cured at 160° C. for 10 min. The screen printed template was 100 mm long and 1 mm wide. Resistivity was measured on a 60 mm segment of the printed ink with a Fluke 45 multimeter, following the ASTM F1896-16 test procedure. The results are shown in Table 1.

Flexibility (Crease) test: The substrate with the 100 mm printed line was folded in half so the two halves of the line touched (inside fold). The fold was creased by rolling an 1840 g circular weight across the fold and then back again. The substrate was then opened and folded in half along the crease in the opposite direction (outside fold) and rolled again back and forth with the weight. The substrate was then opened and flattened and the resistivity measured as described above.

TABLE 1
CNS conductive ink (high loadings) composition and performance

| Example 1 | 1A | 1B | 1C |
|---|---|---|---|
| CNS loading (dry ink) | 3.9% | 5% | 7.5% |
| CNS (g) | 0.61 | 0.79 | 1.22 |
| 25% TPU in acetate (g) | 60 | 60 | 60 |
| Total (g) | 60.61 | 60.79 | 61.22 |
| Coating thickness (μm) | 14 | 15 | 16 |
| Initial SR (ohm/sq) | 136.1 | 83.6 | 52.6 |
| Initial VR (ohm · cm) | 0.20 | 0.13 | 0.08 |
| % SR increase after crease | 103 | 108 | 104 |

% SR Increase after crease = SR after crease (ohm/sq)/Initial SR (ohm/sq) × 100%

### Example 2

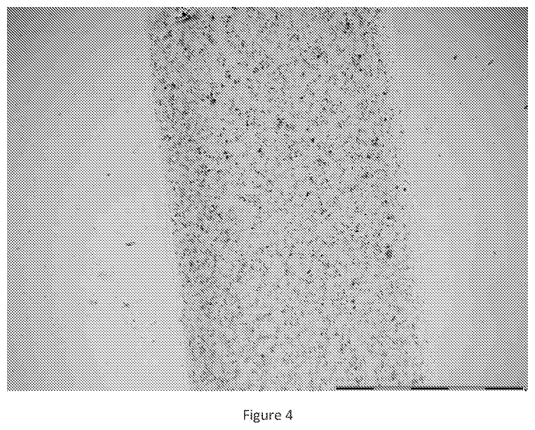

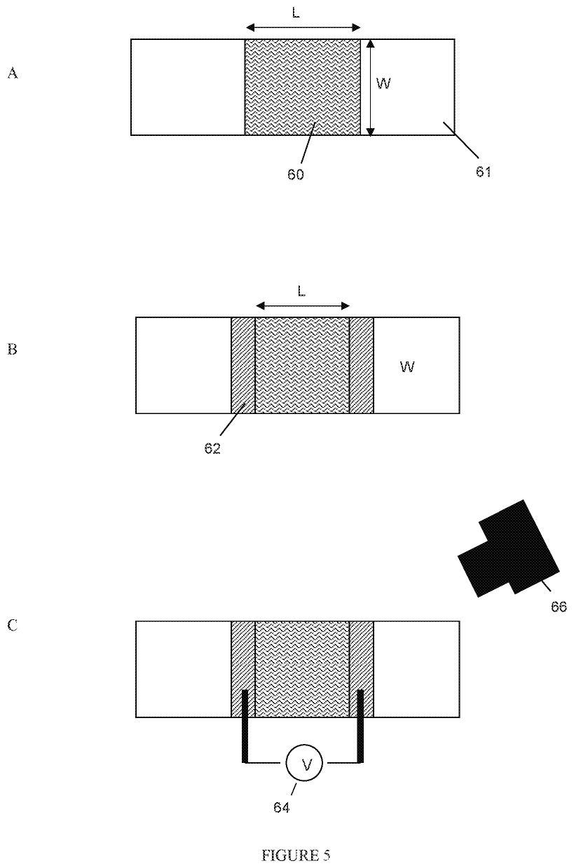

Carbon inks were obtained by diluting (letdown) the samples prepared in Example 1. Table 2 shows the letdown formulation, in which the formulation of Example 1A was diluted to 0.1% to 2% CNS loading. The inks prepared in Example 2 were screen printed, dried, and characterized using the same method described in Example 1. An optical micrograph of the printed ink of Example 2B is shown in FIG. 4 (scale bar=1 mm).

TABLE 2
CNS conductive ink (low loadings) composition and performance

| Example 2 | 2A | 2B | 2C | 2D | 2E |
|---|---|---|---|---|---|
| CNS loading (dry ink) | 0.10% | 0.20% | 0.50% | 1% | 2% |
| CNS Dispersion Ex. 1A (g) | 0.4 | 0.8 | 2 | 4 | 8 |
| 25% TPU in Acetate (g) | 15.59 | 15.18 | 13.94 | 11.88 | 7.76 |
| Total | 15.99 | 15.98 | 15.94 | 15.88 | 15.76 |
| Ink thickness (μm) | 8 | 10 | 13 | 13 | 14 |
| Initial SR (ohm/sq) | 5.1 × 10⁵ | 5.2 × 10⁴ | 5.4 × 10³ | 1.3 × 10³ | 386.1 |
| Initial VR (ohm · cm) | 404.4 | 55.0 | 7.1 | 1.7 | 0.56 |
| % SR increase after crease | 126 | 113 | 100 | 100 | 99 |

### Example 3 (Comparative Example)

Table 3 shows comparative examples including single-walled CNTs, multi-walled CNTs, and carbon black having an iodine number of 253 mg/g and an oil adsorption number of 192 mL/100 g. The 25% TPU resin dispersed in diethylene glycol monoethyl ether acetate solvent from Example 1 was used as binder solution, and samples were prepared and analyzed as described in Example 1. Additional solvent was added to Example 3E to reduce the viscosity of the ink paste.

TABLE 3
Comparative examples of carbon inks and performance

| Example 3 | 3A | 3B | 3C | 3D | 3E | 3F |
|---|---|---|---|---|---|---|
| Carbon loading (dry ink) | 3.88% | 7.5% | 17.4% | 20% | 50% | 20% |
| SWCNT (g) | 0.61 | 1.22 | 0 | 0 | 0 | 0 |
| MWCNT* (g) | 0 | 0 | 3.16 | 0 | 0 | 0 |
| Carbon Black-A** (g) | 0 | 0 | 0 | 1 | 4 | 0 |
| Carbon Black-B*** (g) | 0 | 0 | 0 | 0 | 0 | 1 |
| 25% TPU in acetate (g) | 60 | 60 | 60 | 16 | 16 | 16 |
| Additional Acetate solvent (g) | 0 | 0 | 0 | 0 | 4 | 0 |
| Total (g) | 60.61 | 61.22 | 63.16 | 17 | 24 | 17 |
| Ink thickness (μm) | 8.5 | 13 | 32 | 17 | 15.5 | 28 |
| Initial SR (ohm/sq) | 175.7 | 67.5 | 442.8 | 3.8 × 10³ | 80.0 | 1.8 × 10³ |
| Initial VR (ohm · cm) | 0.15 | 0.09 | 1.4 | 6.5 | 0.12 | 1.66 |
| % SR increase after crease | 107 | 108 | 114 | 120 | 109 | 113 |

*MWCNT: diameter 5-10 nm, length ≥15 μm;
**Carbon Black-A: typical values I2 = 255 g/Kg, DBP OAN = 185 ml/100 g;
***Carbon Black-B: typical values I2 = 120 g/Kg, DBP OAN = 225 ml/100 g;

### Example 4 (Comparative)

Silver inks were prepared according to the formulation listed in Table 4. Silver flakes with a d⁵⁰ of 3 μm were used in the Ag-based ink formulation. The inks were prepared, screen printed onto Kapton polyimide films, and cured as described in Example 1 to form coatings with various amounts of silver. Resistivity and flexibility were characterized as described in Example 1.

TABLE 4
Ag ink composition and performance

| Example 4 | 4A | 4B | 4C | 4D |
|---|---|---|---|---|
| Ag loading (dry ink) | 60% | 70% | 80% | 90% |
| Silver flakes (g) | 6 | 14 | 20 | 27 |
| 25% TPU in Acetate (g) | 16 | 24 | 20 | 12 |
| Total | 22 | 38 | 40 | 39 |
| Ink thickness (μm) | 11 | 15 | 15 | 15 |
| Initial SR (ohm/sq) | 119 | 1.4 | 0.086 | 0.012 |
| Initial VR (ohm · cm) | 0.10 | 2.0 × 10⁻³ | 1.7 × 10⁴ | 1.9 × 10⁻⁵ |
| % SR increase after crease | 201 | 278 | 125 | 146 |

### Example 5

Conductive ink compositions were prepared using a mixture of Ag flakes and CNS, or carbon black and CNS as conductive fillers, as shown in Table 5. Ink formulations were prepared, screenprinted, and characterized as described in Example 1. The results show that, even at only 70% silver loading, the use of 1 wt % CNS brings surface resistivity in range of 0.1-0.2 ohm/sq at 17 μm thickness, a decrease of 10× over the ink composition containing only 70% Ag (Example 4B). Moreover, substituting 5 wt % of silver with 1 wt % CNS maintains resistivity performance as 80% silver loading (Example 5B vs Example 4C).

A combination of CNS (4%) and Carbon black-B (20%) in formulation 5C also noticeably improved the electrical conductivity of the ink formulation 3F with 20% Carbon black-B. The VR dropped from 1˜10 ohm·cm (Example 3F) to approximately 0.1 ohm·cm (Example 5D), which made the carbon ink more conductive.

TABLE 5
Ag/CNS and Carbon Black/CNS ink compositions and performance

| Example 5 | 5A | 5B | 5C | 5D |
|---|---|---|---|---|
| Ag loading (dry ink) | 70% | 75% | 80% | 0% |
| CNS loading (dry ink) | 1.0% | 1.0% | 1.0% | 4.0% |
| Carbon Black-B loading (dry ink) | 0% | 0% | 0% | 20% |
| Binder (dry ink) | 29% | 24.0% | 19% | 76% |
| Silver flakes (g) | 8.4 | 11.25 | 16.0 | 0 |
| CNS Dispersion 1A (g) | 12.0 | 14.56 | 0 | 0 |
| CNS Dispersion 1B (g) | 0 | 0 | 15.38 | 10 |
| CNS Dispersion 1C (g) | 0 | 0 | 0 | 0 |
| 10% Carbon Black “B” in Acetate (g) | 0 | 0 | 0 | 6.5 |
| 25% TPU in Acetate (g) | 2.04 | 0 | 0.015 | 0 |
| Make up solvent (g) | 0 | 4.0 | 6.0 | 0 |
| Total | 22.44 | 29.81 | 37.40 | 16.5 |
| Ink thickness (μm) | 17 | 19 | 16 | 25 |
| Initial SR (ohm/sq) | 0.18 | 0.038 | 0.0037 | 43.3 |
| Initial VR (ohm · cm) | 3.0 × 10⁴ | 7.2 × 10⁻⁵ | 5.7 × 10⁻⁵ | 0.11 |
| % SR increase after crease | 142 | 151 | 160 | 100 |

### Example 6

Heating elements were printed using the inks prepared in previous examples by screen printing six layers of the ink on the substrate to create a heating element about 20-30 microns thick. The schematic of the heating element structure is shown in FIG. 5. The carbon ink 60 is printed on a substrate 61 to create a square 1.2 cm long (L) and 1.0 cm wide (W)(FIG. 5A). Silver ink prepared according to Example 4D was used to form bus bars 62, or electrodes, to provide a connection to a power source 64 and leave a carbon ink square of 1 cm×1 cm (FIG. 5B). A TENMA® 72-7295 DC Regulated Power Supply was used as power source 64 to heat up the printed heating element (FIG. 5C). A FLIR T620 Thermal Imaging Camera 66 was used to measure the temperature profile once the heater reached steady condition. The carbon elements heated up quickly. The heater was considered “steady” when there was no noticeable temperature increase at given voltage.

Table 6 shows the heating performance of the heating elements printed from ink formulations selected from Examples 1, 2 and 3. The results show that CNS based coatings achieve higher temperatures than carbon black-based coatings at voltages over 10V, and also that less voltage is required to achieve temperatures over 100° F. for CNS-based coatings than for carbon black-based coatings.

TABLE 6
Printed heater performance using ink formulations from Examples 1, 2 and 3.

| | | | 6C | 6D | 6F |
|---|---|---|---|---|---|
| | 6A | 6B | Comparative | Comparative | Comparative |
| Ink formulation | Ex. 2D | Ex. 1A | Ex. 3D | Ex. 3F | Ex/3A |
| CNS loading, dry | 1.0% | 3.9% | 0% | 0% | 0% |
| SWCNT loading, dry | 0% | 0% | 0% | 0% | 3.88% |
| Carbon Black-A loading, dry | 0% | 0% | 20% | 0% | 0% |
| Carbon Black-B loading, dry | 0% | 0% | 0% | 20% | 0% |
| Printed Heater Thickness, μm | 25 | 23 | 29 | 29 | 26 |
| Temperature @ 5 V (° F.) | — | 158 | — | — | — |
| Temperature @ 10 V (° F.) | 106 | 270 | 102 | 90 | 160 |
| Temperature @ 15 V (° F.) | — | 572 | N- | — | — |
| Temperature @ 20 V (° F.) | 183 | — | 148 | 117 | — |
| Temperature @ 30 V (° F.) | 290 | — | 215 | 171 | — |
| Temperature @ 40 V (° F.) | 424 | — | 279 | 222 | — |

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A conductive ink comprising 0.05 wt % to 30 wt % (dry basis) of at least one CNS-derived material selected from the group consisting of carbon nanostructures, fragments of carbon nanostructures, and fractured carbon nanotubes, and a binder in a liquid vehicle.

2. The conductive ink of claim 1, having 0.1 wt % to 20 wt %.

3. (canceled)

4. (canceled)

5. The conductive ink of claim 1, wherein the liquid vehicle comprises an organic solvent, water, or both.

6. The conductive ink of claim 1, wherein the binder comprises a polymer, a monomer, an oligomer, or a blend of two or more of these.

7. The conductive ink of claim 1, further comprising a dispersant.

8. The conductive ink of claim 7, wherein the dispersant is a non-ionic dispersant, an anionic dispersant, or a cationic dispersant.

9. The conductive ink of claim 1, further comprising one or more additives selected from a conductive additive, a stabilizer, an antioxidant, an adhesion promoter, and a viscosity modifier.

10. The conductive ink of claim 9, wherein the additive is a conductive additive selected from silver, copper, gold, platinum, palladium, ruthenium, copper, nickel, zinc, and conductive oxides.

11. The conductive ink of claim 9, wherein the conductive additive is in the form of spheres flakes, rods, or wires.

12. The conductive ink of claim 9, wherein the conductive additive is present in an amount from 0 to 99% on a dry basis.

13. The conductive ink of claim 1, wherein, when screen printed and cured, the resulting coating achieves a temperature of at least 300° F. (149° C.) under 40 V of applied voltage.

14. The conductive ink of claim 1, further comprising up to 85% (dry basis) of a metallic particulate, wherein, when screen printed and cured, the resulting coating has a surface resistivity less than a coating having the same composition but without CNS-derived material.

15. The conductive ink of claim 5, wherein the conductive ink comprises from 65% to 83% of the metallic particulate.

16. A substrate having the conductive ink of claim 1 printed thereon, wherein the ink is cured.

17. The substrate of claim 16, wherein the cured ink has a thickness from 0.1 microns to 100 microns.

18. The substrate of claim 16, wherein the cured ink has a volume resistivity of 10⁻⁶ to 10¹⁴ ohm·cm.

19. The substrate of claim 16, wherein the cured ink has a surface resistivity of 10⁻⁶ to 10¹⁴ ohm/sq.

20. The substrate of claim 16, wherein the substrate comprises fabric, paper, wood, metal, glass, ceramic, concrete, polymer, or mixtures or composites of two or more of these.

21. The substrate of claim 20, wherein the substrate comprises a polyolefin, polyimide, polyester, polyurethane, or vinyl polymer.

22. (canceled)

23. The substrate of claim 16, wherein the substrate is a film, a woven fabric, or a non-woven fabric.
